(19) United States
(12) Patent Application Publication
(10) Pub. No.: US 2015/0289199 A1
(43) Pub. Date: Oct. 8, 2015

(54) METHOD AND APPARATUS FOR MANAGING ENTERPRISE ZONE, AND METHOD AND APPARATUS FOR CONTROLLING ACCESS TO ENTERPRISE ZONE

(71) Applicant: ELECTRONICS AND TELECOMMUNICATIONS RESEARCH INSTITUTE, Daejeon (KR)

(72) Inventors: Eun Seon CHO, Daejeon (KR); Chan Yong LEE, Daejeon (KR); Hyung-sub KIM, Daejeon (KR); HyeonJu OH, Daejeon (KR); Yeon Seung SHIN, Daejeon (KR); Pyeong Jung SONG, Daejeon (KR)

(73) Assignee: ELECTRONICS AND TELECOMMUNICATIONS RESEARCH INSTITUTE, Daejeon (KR)

(21) Appl. No.: 14/626,170

(22) Filed: Feb. 19, 2015

(30) Foreign Application Priority Data
Apr. 3, 2014 (KR) 10-2014-0040213

(51) Int. Cl. H04W 48/16

(52) U.S. Cl. CPC H04W 48/16

(57) ABSTRACT

An exemplary embodiment of the present invention provides a method for managing, by a management system, an enterprise zone. The management system constructs information on a plurality of small cell base stations and at least one terminal. The management system allocates at least one closed subscriber group (CSG) ID to the enterprise zone including cells of the small cell base stations. Further, the management system transmits a message for adding the CSG ID to a whitelist of the terminal to the terminal.

### CROSS-REFERENCE TO RELATED APPLICATION

This application claims priority to and the benefit of Korean Patent Application No. 10-2014-0040213 filed in the Korean Intellectual Property Office on Apr. 3, 2014, the entire contents of which are incorporated herein by reference.

### BACKGROUND OF THE INVENTION

1. (a) Field of the Invention

The present invention relates to a method and an apparatus for managing an enterprise zone, and a method and an apparatus for controlling an access of a terminal to an enterprise zone.

2. (b) Description of the Related Art

Recently, a personal base station which is installed inside a room and services a small number of subscribers (for example, 1 to 4 persons) as a target has been proposed. The personal base station is a base station of a category of small cells such as a home base station and manages the small cells (for example, femto cell). The small cell base station is positioned in a cell region having a wide radius of a macro base station which is present outside a room and a considerable number of small cell base stations are present in city environment.

Meanwhile, a service of the small cell base station includes a closed subscriber group (CSG) service which permits services only to a personal user group and does not permit services to other external users and a hybrid service which permits some of the services to other external users. In detail, a CSG ID is allocated to the personal user group and when the allocated CSG ID is identical with an ID of the CSG cell, terminals of the personal user group may access the base station.

Meanwhile, services may be provided to employees of enterprise through a plurality of small cell base stations which are installed in a building of enterprise. A demand for a base station for enterprise is increased. Secret maintenance and security management of enterprise are an important issue and therefore the base station for enterprise needs to essentially have a function of controlling an access of a non-permitted person (or terminal).

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus and a method for setting and releasing an enterprise zone using a CSG service function.

Further, the present invention has been made in an effort to provide a method and an apparatus for controlling an access of a terminal to an enterprise zone.

An exemplary embodiment of the present invention provides a method for managing, by a management system, an enterprise zone. The method includes: constructing information on a plurality of small cell base stations and at least one terminal in a database; allocating at least one closed subscriber group (CSG) ID to the enterprise zone including cells of the small cell base stations; and transmitting a message for adding the CSG ID to a whitelist of the terminal to the terminal.

The allocating may include transmitting, by an enterprise management server of the management system, an enterprise zone setting request message including a first list which is a list of the small cell base stations and a second list which is a list of the terminals to a base station management server of the management system.

The allocating may further include: transmitting, by the base station management server, a CSG ID allocation request message including the second list to a CSG management server of the management system; and allocating, by the CSG management server, the CSG ID which is used in the enterprise zone and transmitting the CSG ID to the base station management server.

The allocating may further include transmitting, by the base station management server, a response message including the CSG ID to the enterprise management server.

The method may further include: receiving, by the base station management server, a request of base station installation information from a first base station; determining, by the base station management server, whether the first base station is a small cell base station included in the first list; and transmitting installation information including the CSG ID to the first base station based on the determination result.

The transmitting of the installation information to the terminal may include: transmitting, by the CSG management server, a CSG ID setting message including the CSG ID to mobility management entity (MME) of the management system; and transmitting, by the MME, a non access stratum (NAS) message requesting an addition of the CSG ID to the terminal.

The enterprise management server may include: the database; an authentication server performing terminal authentication to control an access of the terminal to the enterprise zone; and an application server providing an application service to the authenticated terminal among the terminals.

Another embodiment of the present invention provides a method for managing, by a management system, a zone. The method includes: releasing at least CSG ID allocated to the zone; requesting a plurality of small cell base stations forming the zone to remove the CSG ID from configuration information; and requesting at least one terminal accessible to the zone to remove the CSG ID from a whitelist.

The zone may be an enterprise zone. The releasing may include: transmitting, by an enterprise management server of the management system, an enterprise zone releasing request message including a first list which is a list of the small cell base stations and a second list which is a list of the terminals to a base station management server of the management system; transmitting, by the base station management server, a CSG ID releasing request message including the second list to a CSG management server of the management system; and releasing, by the CSG management server, the CSG ID.

The requesting of the small cell base stations may include: transmitting, by the base station management server, a message requesting a removal of the CSG ID from the configuration information to the small cell base stations.

The requesting of the terminal may include: transmitting, by the base station management server, a message for deleting the CSG ID from a whitelist of the terminal to the MME of the management system; and transmitting, by the MME, a NAS message requesting a deletion of the CSG ID to the terminal.

Still another exemplary embodiment of the present invention provides a method for controlling, a management system, an access of a terminal to a zone. The method includes: authenticating the terminal using at least one CSG ID allocated to the zone when the terminal enters the zone formed by a plurality of small cell base stations; determining whether the terminal has a right to use an application service in the zone; and providing the application service to the terminal based on the determination result.

The zone may be an enterprise zone.

The authenticating may include: receiving, by an MME of the management system, a first message requesting the authentication of the terminal from a first small cell base station of the small cell base stations when the CSG ID is included in a whitelist of the terminal; and requesting, by the MME, CSG information on the terminal of a CSG management server of the management system.

The authenticating may further include: performing, by the MME, the authentication of the terminal using the CSG ID and the CSG information which are included in the first message; and transmitting, by the MME, a second message including an authentication result of the terminal to the first small cell base station.

The determining whether the terminal has a right to use an application service in the zone may include: receiving, by an enterprise management server of the management system, a third message requesting authentication on the right from the first small cell base station; and performing, by the enterprise management server, the authentication on the right using the authentication information of the terminal included the third message.

The method may further include: receiving, by the MME of the management system, a first message requesting an access release of the terminal to the enterprise zone from a first small cell base station of the small cell base stations when the terminal is out of the enterprise zone; and transmitting, by the MME, a second message including a result of the access release to the first small cell base station.

The method may further include: receiving, by an enterprise management server of the management system, a third message requesting a use stop of the terminal for the application service from the first small cell base station; and transmitting, by the enterprise management server, a fourth message including a result of the use stop to the first small cell base station.

The terminal may include an authentication processor performing authentication for being accessed to the enterprise zone.

### BRIEF DESCRIPTION OF THE DRAWINGS

FIG. 1 is a diagram illustrating an enterprise zone and an enterprise management system according to an exemplary embodiment of the present invention.

FIG. 2 is a diagram illustrating a configuration of a mobile terminal according to an exemplary embodiment of the present invention.

FIG. 3 is a diagram illustrating a configuration of an enterprise management server according to an exemplary embodiment of the present invention.

FIG. 4 is a flow chart illustrating a process of setting an enterprise zone according to an exemplary embodiment of the present invention.

FIG. 5 is a flow chart illustrating a process of releasing an enterprise zone according to an exemplary embodiment of the present invention.

FIG. 6 is a flow chart illustrating a process of controlling an access of a terminal to an enterprise zone according to the exemplary embodiment of the present invention.

FIG. 7 is a flow chart illustrating a process of controlling an access release of a terminal to an enterprise zone according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a mobile terminal (MT) may be called a terminal, a mobile station (MS), an advanced mobile station (AMS), a high reliability mobile station (HR-MS), a subscriber station (SS), a portable subscriber station (PSS), an access terminal (AT), user equipment (UE), and the like and may also include functions of all or some of the terminal, the MT, the MS, the AMS, the HR-MS, the SS, the PSS, the AT, the UE, and the like.

Further, a small cell base station may be called a base station (BS), an advanced base station (ABS), a high reliability base station (HR-BS), a nodeB, an evolved node B (eNodeB), an access point (AP), a radio access station (RAS), a base transceiver station (BTS), a mobile multihop relay (MMR)-BS, a relay station (RS) serving as a base station, a high reliability relay station (HR-RS) serving as a base station, and the like and may also include functions of all or some of the BS, the ABS, the nodeB, the eNodeB, the AP, the RAS, the BTS, the MMR-BS, the RS, the HR-BS, and the like.

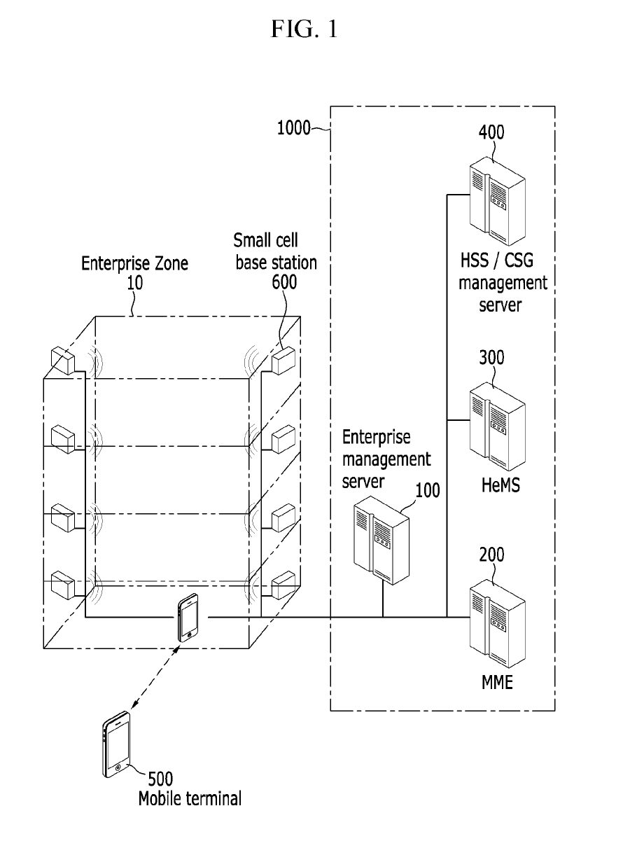

FIG. 1 is a diagram illustrating an enterprise zone 10 and an enterprise management system 1000 according to an exemplary embodiment of the present invention.

The enterprise zone 10 may be configured of at least one small cell base station 600. For convenience of explanation, FIG. 1 illustrates a case in which the enterprise zone 10 includes cells of eight small cell base stations 600. In detail, the small cell base stations 600 may be installed in a building of one enterprise. When a mobile terminal 500 enters the enterprise zone 10, the enterprise management system 1000 inspects whether the mobile terminal 500 is a terminal which may access the enterprise zone 10 including at least one closed subscriber (service) group (CSG) cell using a CSG identifier (ID). In a case in which the mobile terminal 500 is a terminal which may access the enterprise zone 10, the enterprise management system 1000 performs an authentication procedure which inspects whether the mobile terminal 500 is a terminal which may access enterprise application.

The enterprise management system 1000 manages the enterprise zone 10. In detail, the enterprise management system 1000 includes an enterprise management server 100, a mobility management entity (MME) 200, a home eNodeB management system (HeMS) 300, and a home subscriber server (HSS)/CSG management server 400.

The HeMS 300 is a server which is connected to the small cell base station 600 and manages the small cell base station 600. In detail, the HeMS 300 performs a function required to operate and run the small cell base station 600.

The MME 200 permits an access of the mobile terminal 500 to the small cell base station 600. The MME 200 is a net structure and is connected to the small cell base station 600 and the enterprise management server 100.

The HSS/CSG management server 400 is connected to the MME 200 and the HeMS 300 and performs allocation and release of CSG (or CSG ID) to and from the small cell base station 600 and the mobile terminal 500. Hereinafter, for convenience of explanation, the HSS/CSG management server 400 is called the CSG management server 400.

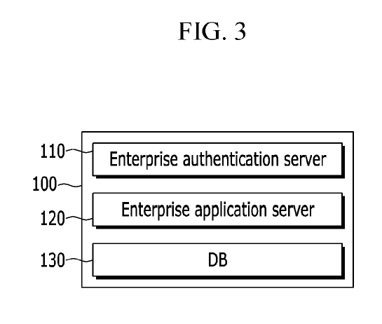

The enterprise management server 100 controls an access of the mobile terminal 500 to the enterprise application provided within the enterprise zone 10. The enterprise management server 100 will be described in detail with reference to FIG. 3.

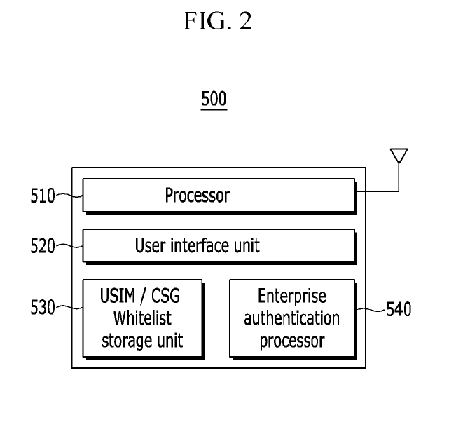

FIG. 2 is a diagram illustrating a configuration of the mobile terminal 500 according to an exemplary embodiment of the present invention.

The mobile terminal 500 may include a processor 510, a user interface unit 520, an USIM/CSG whitelist storage unit 530, and an enterprise authentication processor 540.

The processor 510 performs the existing function (basic function) of the mobile terminal 500.

The user interface unit 520 performs interfacing with a user.

The USIM/CSG whitelist storage unit 530 stores a universal subscriber identity module (USIM) and a CSG whitelist.

The enterprise authentication processor 540 performs an authentication function of an access to the enterprise zone 10 or an access to the enterprise application.

FIG. 3 is a diagram illustrating a configuration of the enterprise management server 100 according to an exemplary embodiment of the present invention.

The enterprise management server 100 may include an enterprise authentication server 110, an enterprise application server 120, and a database 130.

The enterprise authentication server 110 performs an authentication function to control the access of the mobile terminal 500 to the enterprise application.

The enterprise application server 120 provides the enterprise application service to the authenticated mobile terminal 600 by the enterprise authentication server 110.

The database 130 stores a list (hereinafter, ‘list of base stations’) of the small cell base stations 600 forming the enterprise zone 10 and a list (hereinafter, ‘list of permitted terminals’) of the mobile terminals 500 which may access the enterprise zone 10.

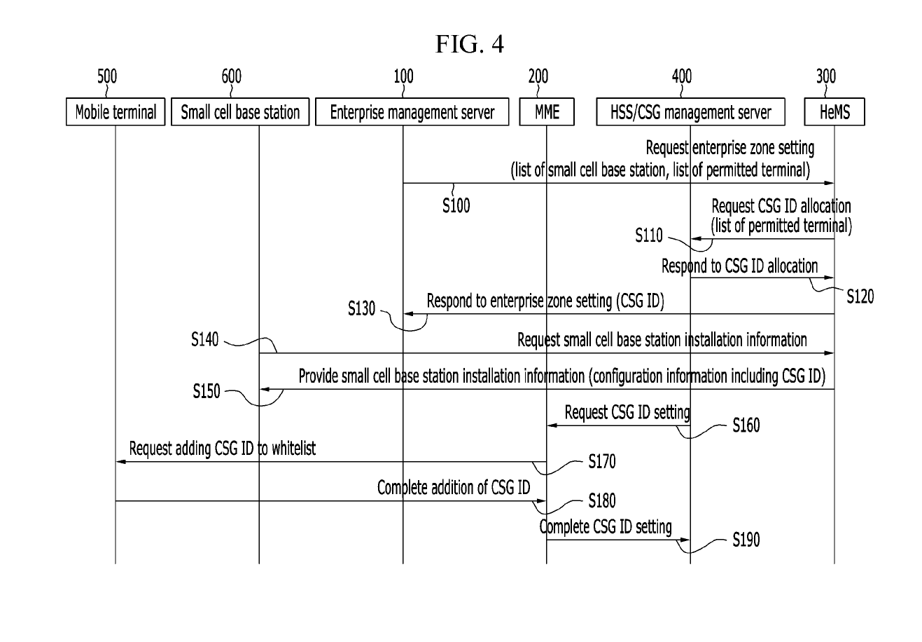

FIG. 4 is a flow chart illustrating a process of setting the enterprise zone 10 according to an exemplary embodiment of the present invention.

To form the enterprise zone 10 in a building of one enterprise, the enterprise management server 100 builds information on at least one small cell base station 600 which will be used within the enterprise zone 10 and information of the mobile terminal 500 which may access the enterprise zone 10.

The enterprise management server 100 transmits the list of the base stations and the list of the permitted terminals which are stored in the database 130 to the HeMS 300 and requests the HeMS 300 to set the enterprise zone (S100). In detail, the enterprise management server 100 may transmit an enterprise zone setting request message including the list of the base stations and the list of the permitted terminals to the HeMS 300.

The HeMS 300 transmits the list of the permitted terminals to the CSG management server 400 and requests the CSG management server to allocate the CSG ID (S110). In detail, the HeMS 300 may transmit the CSG ID allocation request message including the list of the permitted terminals to the CSG management server 400.

The CSG management server 400 allocates at least one CSG ID which will be used in the enterprise zone 10 and informs the allocated CSG ID of the HeMS 300 (S120). In detail, the CSG management server 400 may allocate one CSG ID for the whole enterprise zone 10. In this case, the same one CSG ID is allocated to all of the small cell base stations 600 forming the enterprise zone 10. Alternatively, the CSG management server 400 may also allocate the plurality of CSG ID for a detailed region of the enterprise zone 10. In this case, each of the small cell base station groups including at least one small cell base station 600 corresponds to each detailed region of the enterprise zone 10 and is allocated with different CSG IDs.

The HeMS 300 transmits an enterprise zone setting request response message including the allocated CSG ID to the enterprise management server 100 (S130).

Meanwhile, when the small cell base station 600 is turned on (power on), an auto configuration process is performed. In this case, small cell base station installation information requests the HeMS 300 (S140).

The HeMS 300 confirms whether the small cell base station 600 requesting the base station installation information is a base station included in the enterprise zone 10. In detail, the HeMS 300 determines whether the small cell base station 600 requesting the small cell base station installation information is included in the list of the base stations. If it is determined that the small cell base station 600 is included in the list of the base stations, the HeMS 300 provides the configuration information (installation information) including the CSG ID allocated to the enterprise zone 10 to the corresponding small cell base station 300 (S150).

The CSG management server 160 transmits a terminal CSG ID setting request message to the MME 200 to add the CSG ID allocated to the enterprise zone 10 to the CSG whitelist of the mobile terminal 500 included in the list of the terminals permitting the CSG IDs allocated to the enterprise zone 10 (S160).

The MME 200 requests the mobile terminals 500 included in the list of the permitted terminals to add the CSG ID (S170). In addition, the MME 200 may transmit a non access stratum (NAS) message requesting an addition of the CSG ID to the mobile terminal 500.

The mobile terminal 500 receiving the NAS message adds the received CSG ID to its own CSG whitelist and transmits a CSG ID addition completion message to the MME 200 (S180). In detail, the mobile terminal 500 may transmit the NAS message informing the addition completion of the CSG ID to the MME 200.

The MME 200 transmits a terminal CSG ID setting completion message to the CSG management server 400 (S190).

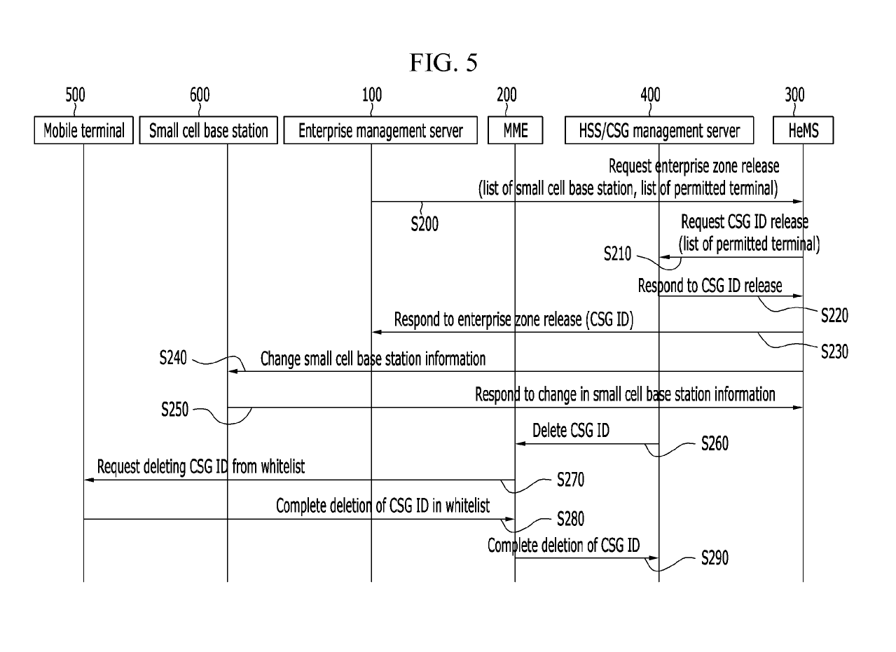

FIG. 5 is a flow chart illustrating a process of releasing an enterprise zone 10 according to an exemplary embodiment of the present invention.

To release the enterprise zone 10, the enterprise management server 100 transmits the list of the base stations and the list of the permitted terminals to the HeMS 300 and requests the HeMS 300 to release the enterprise zone (S200). In detail, the enterprise management server 100 may transmit an enterprise zone releasing request message including the list of the base stations and the list of the permitted terminals to the HeMS 300.

The HeMS 300 transmits the list of the permitted terminals to the CSG management server 400 and requests the CSG management server to release the CSG ID (S210). In detail, the HeMS 300 may transmit a CSG ID release request message including the list of the permitted terminals to the CSG management server 400.

The CSG management server 400 releases at least one CSG ID allocated to the enterprise zone 10 and informs the HeMS 300 of the released result (S220).

The HeMS 300 transmits a response message to the enterprise zone releasing request to the enterprise management server 100 (S230). In detail, the HeMS 300 may transmit a response message including the deallocated CSG ID to the enterprise management server 100.

The HeMS 300 requests the small cell base stations 600 included in the enterprise zone 10 to remove (or change) the CSG ID allocated to the enterprise zone 10 in the configuration information (or setting information) (S240). In detail, the HeMS 300 may transmit a configuration information change message for removing the corresponding CSG ID from the configuration information to the small cell base stations 600 included in the list of the base stations.

The small cell base stations 600 receiving the configuration information change message changes (delete the corresponding CSG ID) its own configuration information and transmits the response message to the configuration information change request to the HeMS 300 (S250).

To remove the CSG ID allocated to the enterprise zone 10 from the CSG whitelist of the mobile terminal 500 (or mobile terminals 500 included in the list of the permitted terminals) included in the enterprise zone 10, the CSG management server 400 transmits a terminal CSG ID deletion request message to the MME 200 (S260).

The MME 200 requests the mobile terminals 500 included in the list of the permitted terminals to delete the CSG ID allocated to the enterprise zone 10 from the CSG whitelist (S270). In detail, the MME 200 may transmit the NAS message requesting the deletion of the CSG ID to the mobile terminal 500.

The mobile terminal 500 receiving the NAS message deletes the received CSG ID from its own CSG whitelist. Further, the mobile terminal 500 transmits a CSG ID deletion completion message to the MME 200 (S280). In detail, the mobile terminal 500 may transmit the NAS message informing the deletion completion of the CSG ID to the MME 200.

The MME 200 transmits a terminal CSG ID deletion completion message to the CSG management server 400 (S290).

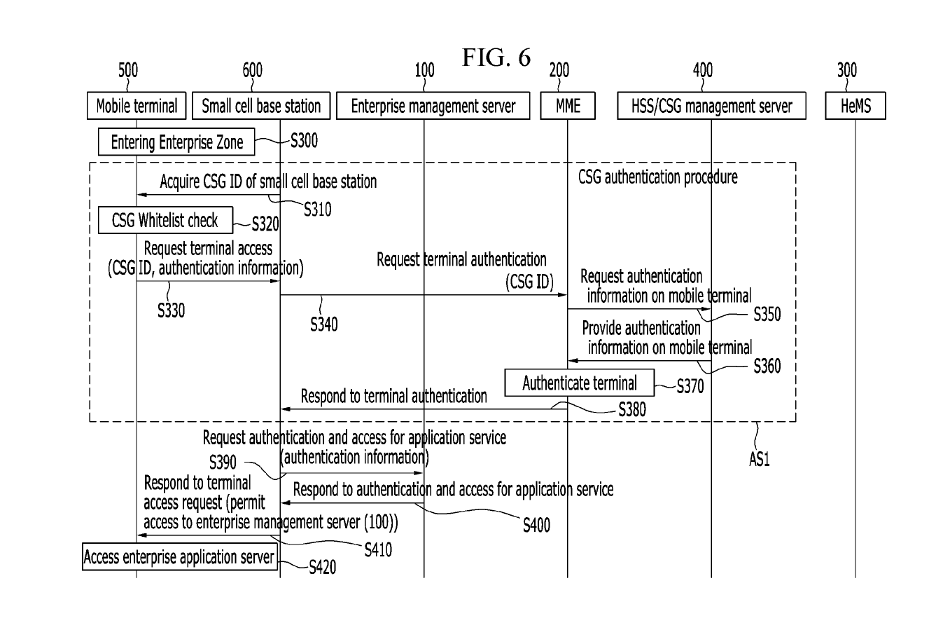

FIG. 6 is a flow chart illustrating a process of controlling an access a mobile terminal 500 to an enterprise zone according to the exemplary embodiment of the present invention. In detail, FIG. 6 illustrates an access control process when the mobile terminal 500 enters the enterprise zone 10.

The mobile terminal 500 enters the enterprise zone 10 (S300). A method for accessing a mobile terminal 500 to a small cell base station 600 is changed depending on the state of the mobile terminal 500. In detail, any one of an attach procedure and a handover procedure may be performed depending on the state of the mobile terminal 500. Each of the attach procedure and the handover procedure includes a CSG authentication procedure AS1 which authenticates the CSG ID of the mobile terminal 500.

When entering a building in which the enterprise zone 10 is installed, the mobile terminal 500 receives a system information message broadcast by the small cell base station 600 forming the enterprise zone 10. The mobile terminal 500 recognizes that a cell of the small cell base station 600 is a CSG cell using the system information message and acquires the CSG ID of the small cell base station 600 (S310).

The mobile terminal 500 compares the acquired CSG ID with the CSG ID included in its own CSG whitelist (S320). When the acquired CSG ID is included in its own CSG whitelist, the mobile terminal 500 transmits the corresponding CSG ID and the authentication information to the corresponding small cell base station 600 and requests an access (S330). In detail, the mobile terminal 500 may transmit an access request message including the corresponding CSG ID and the authentication information to the corresponding small cell base station 600.

To authenticate the mobile terminal 500, the small cell base station 600 transmits the CSG ID of the mobile terminal 500 to the MME 200 and requests the terminal authentication (S340). In detail, the small cell base station 600 may transmit a terminal authentication request message including the received CSG ID to the MME 200.

The MME 200 requests the authentication information on the mobile terminal 500 of the CSG management server 400 (S350). In detail, the MME 200 may transmit an international mobile subscriber identity (IMSI) value of the mobile terminal 500 to the CSG management server 400.

The CSG management server 400 provides the requested authentication information (for example, CSG subscriber data for the mobile terminal 500) to the MME 200 (S360).

The MME 200 performs the authentication of the mobile terminal 500 using the information received from the CSG management server 400 (S370). In detail, the MME 200 may perform the authentication of the mobile terminal 500 using the CSG ID included in the terminal authentication request message and the CSG information on the mobile terminal 500 which is received from the CSG management server 400. Further, when the terminal authentication is completed, the MME 200 transmits the response message to the terminal authentication to the small cell base station 600 (S380).

To confirm whether the mobile terminal 500 may access the enterprise application, the small cell base station 600 transmits the terminal authentication and the access request message for enterprise application service to the enterprise management server 100 (S390). The terminal authentication and the access request message which are transmitted by the small cell base station 600 may include the authentication information of the terminal.

The enterprise management server 100 performs the authentication on whether the mobile terminal 500 may access the enterprise application using the authentication information of the terminal. Further, when the authentication is successfully completed, the enterprise management server 100 transmits the response message to the terminal authentication and the access request for application service to the small cell base station 600 (S400).

The small cell base station 600 transmits the response message to the terminal access request to the mobile terminal 500 (S410).

When processes S300 to S410 are successfully completed, the mobile terminal 500 entering the enterprise zone 10 may access the enterprise management server 100 (in detail, enterprise application server 120) to use the desired application service (S420).

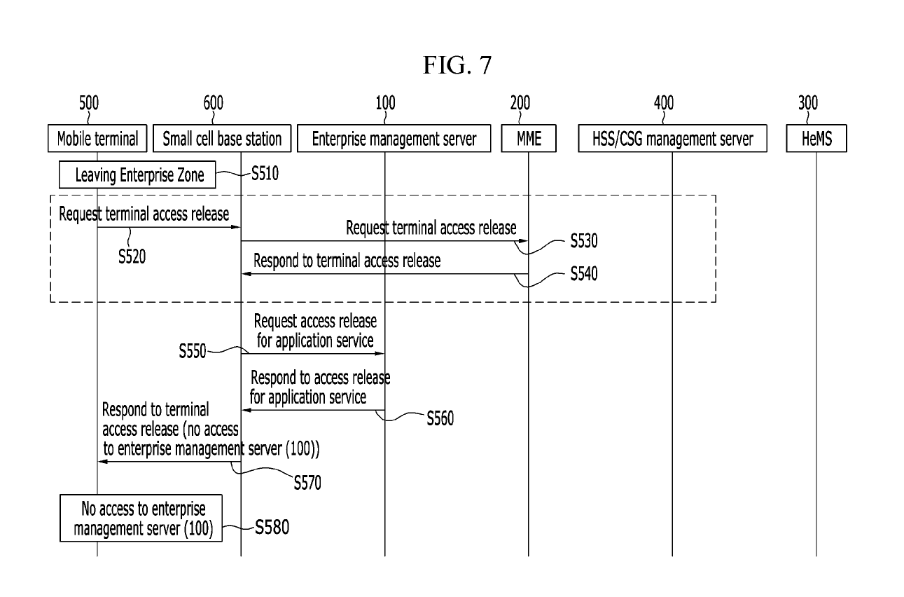

FIG. 7 is a flow chart illustrating a process of controlling an access release of a mobile terminal 500 to an enterprise zone 10 according to the exemplary embodiment of the present invention. In detail, FIG. 7 illustrates an access release process when the mobile terminal 500 enters the enterprise zone 10.

When the mobile terminal 500 is out of the enterprise zone 10 (S510), the mobile terminal 500 requests the small cell base station 600 to which the mobile terminal 500 is accessed to release the access (S520).

The small cell base station 600 receiving the access release request transmits the terminal access release request message to the MME 200 (S530).

The MME 200 performs the access release of the mobile terminal 500 and transmits the response message to the terminal access release request to the small cell base station 600 (S540).

Meanwhile, to inhibit (or intercept) the mobile terminal 500 which is out of the enterprise zone 10 from being accessed to the enterprise application, the small cell base station 600 requests the enterprise management server 100 to release the access to the enterprise application service 120 (S550). In detail, the small cell base station 600 may transmit the access release request message for intercepting the mobile terminal 500 from being accessed to the enterprise application server 120 to the enterprise management server 100.

The enterprise management server 100 transmits the response message to the application service access release request to the small cell base station 600 (S560). In detail, the enterprise management server 100 may delete the corresponding mobile terminal 500 from the list of the permitted terminals and may transmit the response message to the application service access release request to the small cell base station 600.

The small cell base station 600 transmits the response message to the access release request to the mobile terminal 500 (S570).

When processes S510 to S570 are successfully completed, the mobile terminal 500 which is out of the enterprise zone 10 may not access the enterprise management server 100 (in detail, enterprise application server 120) (S580). In detail, when the mobile terminal 500 is deleted from the list of the permitted terminals, it is possible to inhibit (or intercept) the mobile terminal from being accessed to the enterprise application server 120. Thereby, the mobile terminal 500 which is out of the enterprise zone 10 may not use the enterprise application service.

According to the exemplary embodiments of the present invention, it is possible to set and release the enterprise zone using the CSG service function. Here, the enterprise zone may be formed by the plurality of small cell base stations which are installed in a building of one enterprise. Further, according to the exemplary embodiments of the present invention, it is possible to control the access of the terminals to the enterprise zone and perform the terminal authentication for using enterprise applications.

According to the exemplary embodiments of the present invention, it is possible to form the enterprise zone using the plurality of small cell base stations which are installed in the building of enterprise. Further, according to the exemplary embodiments of the present invention, it is possible to permit the access of only the terminals (for example, the pre-registered terminals of individual ownership) in the enterprise zone to the ownership applications or the security data of enterprise using the function of the CSG service. Further, it is possible to inhibit (intercept) the access of the terminal to the application or the security data when the terminal is out of the enterprise zone. Thereby, it is possible to efficiently keep the security of enterprise.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for managing, by a management system, an enterprise zone, comprising:
constructing information on a plurality of small cell base stations and at least one terminal in a database;
allocating at least one closed subscriber group (CSG) ID to the enterprise zone including cells of the small cell base stations; and
transmitting a message for adding the CSG ID to a whitelist of the terminal to the terminal.

2. The method of claim 1, wherein the allocating includes transmitting, by an enterprise management server of the management system, an enterprise zone setting request message including a first list which is a list of the small cell base stations and a second list which is a list of the terminals to a base station management server of the management system.

3. The method of claim 2, wherein the allocating further includes:
transmitting, by the base station management server, a CSG ID allocation request message including the second list to a CSG management server of the management system; and
allocating, by the CSG management server, the CSG ID which is used in the enterprise zone and transmitting the CSG ID to the base station management server.

4. The method of claim 3, wherein the allocating further includes transmitting, by the base station management server, a response message including the CSG ID to the enterprise management server.

5. The method of claim 4, further comprising:
receiving, by the base station management server, a request of base station installation information from a first base station;
determining, by the base station management server, whether the first base station is a small cell base station included in the first list; and
transmitting installation information including the CSG ID to the first base station based on the determination result.

6. The method of claim 5, wherein the transmitting of the installation information to the terminal includes:
transmitting, by the CSG management server, a CSG ID setting message including the CSG ID to mobility management entity of the management system; and
transmitting, by the MME, a non access stratum (NAS) message requesting an addition of the CSG ID to the terminal.

7. The method of claim 2, wherein the enterprise management server includes:
the database;
an authentication server performing terminal authentication to control an access of the terminal to the enterprise zone; and
an application server providing an application service to the authenticated terminal among the terminals.

8. A method for managing, by a management system, a zone, comprising:
releasing at least closed subscriber group (CSG) ID allocated to the zone;
requesting a plurality of small cell base stations forming the zone to remove the CSG ID from configuration information; and
requesting at least one terminal that is permitted access to the zone to remove the CSG ID from a whitelist.

9. The method of claim 8, wherein the zone is an enterprise zone, and the releasing includes:
transmitting, by an enterprise management server of the management system, an enterprise zone releasing request message including a first list which is a list of the small cell base stations and a second list which is a list of the terminals to a base station management server of the management system.
transmitting, by the base station management server, a CSG ID releasing request message including the second list to a CSG management server of the management system; and
releasing, by the CSG management server, the CSG ID.

10. The method of claim 9, wherein the requesting of the small cell base stations includes transmitting, by the base station management server, a message requesting a removal of the CSG ID from the configuration information to the small cell base stations.

11. The method of claim 10, wherein the requesting of the terminal includes:
transmitting, by the base station management server, a message for deleting the CSG ID from a whitelist of the terminal to mobility management entity (MME) of the management system; and
transmitting, by the MME, a non access stratum (NAS) message requesting a deletion of the CSG ID to the terminal.

12. The method of claim 9, wherein the enterprise management server includes:
a database including the first list and the second list;
an authentication server performing terminal authentication to control an access of the terminal to the enterprise zone; and
an application server providing an application service to the authenticated terminal among the terminals.

13. A method for controlling, by a management system, an access of a terminal to a zone, comprising:
authenticating the terminal using at least one closed subscriber group (CSG) ID allocated to the zone when the terminal enters the zone formed by a plurality of small cell base stations;
determining whether the terminal has a right to use an application service in the zone; and
providing the application service to the terminal based on the determination result.

14. The method of claim 13, wherein the zone is an enterprise zone, and the authenticating includes:
receiving, by an mobility management entity (MME) of the management system, a first message requesting the authentication of the terminal from a first small cell base station of the small cell base stations when the CSG ID is included in a whitelist of the terminal; and
requesting, by the MME, CSG information on the terminal of a CSG management server of the management system.

15. The method of claim 14, wherein the authenticating further includes:
performing, by the MME, the authentication of the terminal using the CSG ID and the CSG information which are included in the first message; and
transmitting, by the MME, a second message including an authentication result of the terminal to the first small cell base station.

16. The method of claim 15, wherein the determining whether the terminal has a right to use an application service in the zone includes:
receiving, by an enterprise management server of the management system, a third message requesting authentication on the right from the first small cell base station; and
performing, by the enterprise management server, the authentication on the right using authentication information of the terminal included the third message.

17. The method of claim 13, further comprising:
receiving, by mobility management entity (MME) of the management system, a first message requesting an access release of the terminal to the zone from a first small cell base station of the small cell base stations when the terminal is out of the zone; and
transmitting, by the MME, a second message including a result of the access release to the first small cell base station,
wherein the zone is an enterprise zone.

18. The method of claim 17, further comprising:
receiving, by an enterprise management server of the management system, a third message requesting a use stop of the terminal for the application service from the first small cell base station; and
transmitting, by the enterprise management server, a fourth message including a result of the use stop to the first small cell base station.

19. The method of claim 18, wherein the enterprise management server includes:
a database including a list of the small cell base stations and a list of terminals that are permitted access to the enterprise zone;
an authentication server performing terminal authentication to control an access of the terminal to the enterprise zone; and
an application server providing the application service.

20. The method of claim 13, wherein the zone is an enterprise zone, and the terminal includes an authentication processor performing authentication for being accessed to the enterprise zone.
